(19) United States
(12) Patent Application Publication
(10) Pub. No.: US 2015/0113453 A1
(43) Pub. Date: Apr. 23, 2015

(54) METHODS AND DEVICES FOR SIMPLIFIED GRAPHICAL OBJECT EDITING

(71) Applicant: APPLE INC., Cupertino, CA (US)

(72) Inventor: William J. Thimbleby, Sunnyvale, CA (US)

(73) Assignee: APPLE INC., Cupertino, CA (US)

(21) Appl. No.: 14/057,850

(22) Filed: Oct. 18, 2013

(51) Int. Cl. G06F 3/0484; G06F 3/0486; G06F 3/0487; G06F 3/0481

(52) U.S. Cl. CPC G06F 3/04845; G06F 3/04817; G06F 3/0486; G06F 3/0487
USPC 715/765

(57) ABSTRACT

Devices and methods for correcting distortion of misshapen objects in graphical object editing applications are provided. The methods may include displaying on an electronic device a graphical user interface (GUI) including a graphical object. The graphical object includes one or more controllable graphical nodes. The methods include detecting a user input via a processor of the electronic device. The user input includes a selection to reshape the graphical object. The methods further include deriving a first model of the graphical object and a second model of the reshaped graphical object, calculating an incongruence between the graphical object and the first model, deriving a third model of the reshaped graphical object based on the second model and the incongruence, and reshaping the graphical object in accordance with the second model or the third model based on a value of a second incongruence calculated between the graphical object and the third model.

### BACKGROUND

The present disclosure relates generally to graphical editing and, more particularly, to editing graphical objects in a simplified manner from a user's perspective.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic graphics editing may involve drawing letters, lines, shapes, vector shapes, and/or other general objects. For example, users may draw or construct scalar vector graphics (SVG) paths, which may include many control points that define the path. For example, to construct a Bezier path, for example, many nodes may define a path (e.g., closed path) that connects the points according to a particular mathematical function. Control handles allow the users to manipulate the gradient of the path as it passes through the nodes. However, the user may find the use of control handles to edit certain paths to be non-intuitive, particularly as the control handles are not on the path and may manipulate the path in non-obvious ways.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to methods and devices for pen tools of a graphical user interface (GUI) or other user object editing application. The present embodiments may allow a user to edit (e.g., distort and/or reshape) a user-selected and/or user-drawn object both when the object corresponds to mathematically even and smooth object (e.g., circle, oval, square object) and when the path does not correspond to a mathematically smooth and even object (e.g., misshapen or grotesque objects). Specifically, mathematically even and smooth models of the edited object may be derived as the user edits the object. These models may be then provided as mathematically even and smooth templates for which the object morphs toward as the user continuously edits the object. Thus, the present embodiments may ensure that as a user, for example, edits (e.g., moves a node of an object) the original form of the object, the final resulting form will morph toward a shape being more mathematically ideal and smooth curves and convexity. This is the case even when the object being edited does not entirely correspond to a mathematically ideal and/or mathematically smooth shape.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with aspects of the present disclosure;

FIG. 2 is a front view of a handheld device, such as an iPhone® by Apple Inc., representing an example of the electronic device of FIG. 1;

FIG. 3 is a front view of a tablet device, such as an iPad® by Apple Inc., representing an example of the electronic device of FIG. 1;

FIG. 4 is a perspective view of a notebook computer, such as a MacBook Pro® by Apple Inc., representing an example of the electronic device of FIG. 1;

FIG. 5 illustrates a edit mode screen of an editing application and a graphical object, in accordance with aspects of the present disclosure;

FIG. 6 is a flowchart of an embodiment of a process suitable for distortion correction in graphical object editing, in accordance with present embodiments;

FIG. 7 illustrates the graphical object of FIG. 5 including a first model of the graphical object, in accordance with aspects of the present disclosure;

FIG. 8 illustrates a distorted view of the graphical object of FIG. 5 including a second model of the distorted graphical object, in accordance with aspects of the present disclosure;

FIG. 9 illustrates a second model of the graphical object of FIG. 5, in accordance with aspects of the present disclosure;

FIG. 10 illustrates a morphing of the graphical object of FIG. 5 between the second model and the third model of the graphical object, in accordance with aspects of the present disclosure;

FIGS. 11-13 illustrate additional example embodiments of morphing between the second model and the third model of the graphical object, in accordance with aspects of the present disclosure; and

FIG. 14 illustrates the graphical object including an add-node, in accordance with aspects of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

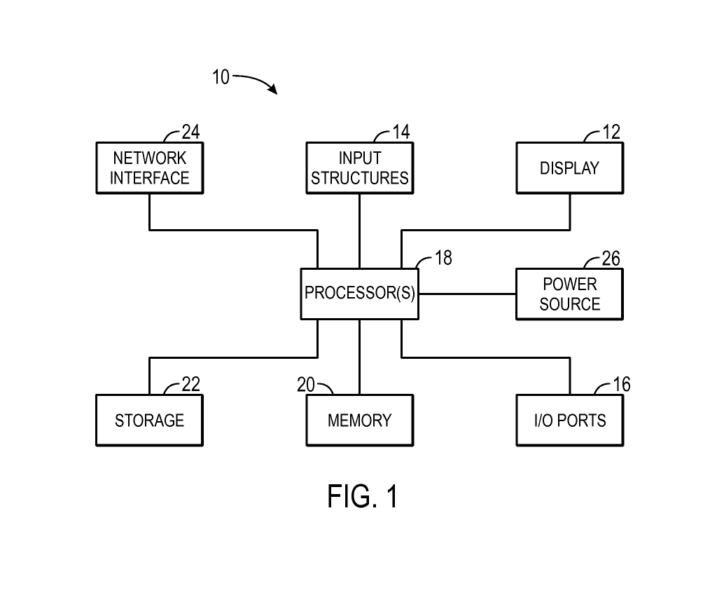

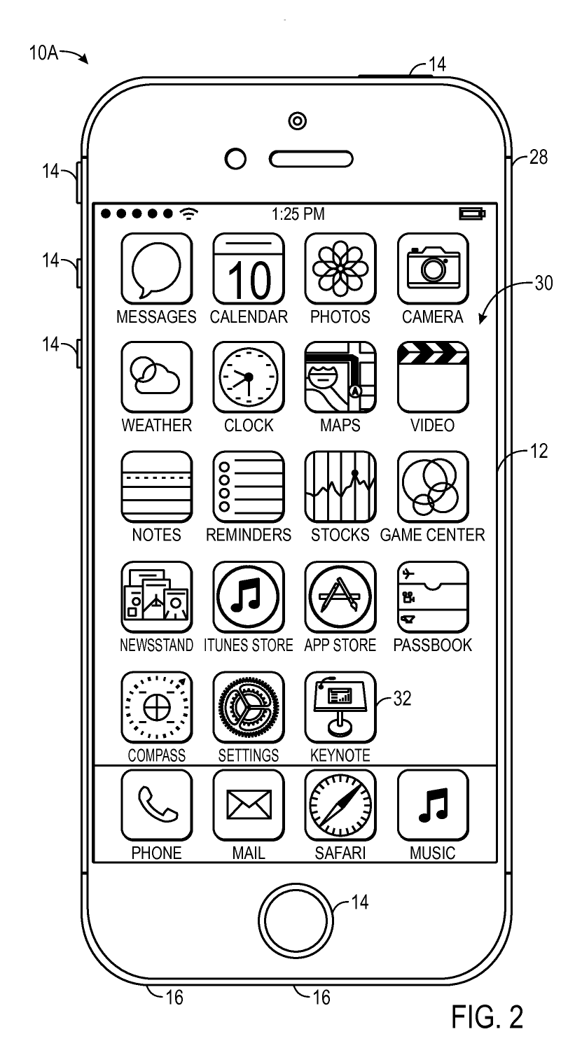

A variety of suitable electronic devices may employ the techniques described below. FIG. 1, for example, is a block diagram depicting various components that may be present in a suitable electronic device 10. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22, a network interface 24, and a power source 26. The various functional blocks shown in FIG. 1 may include hardware elements (including circuitry), software elements (including computer code stored on a non-transitory computer-readable medium) or a combination of both hardware and software elements. It should be noted that FIG. 1 is merely one example of a particular implementation and is intended to illustrate the types of components that may be present in the electronic device 10. Indeed, the various depicted components (e.g., the processor(s) 18) may be separate components, components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

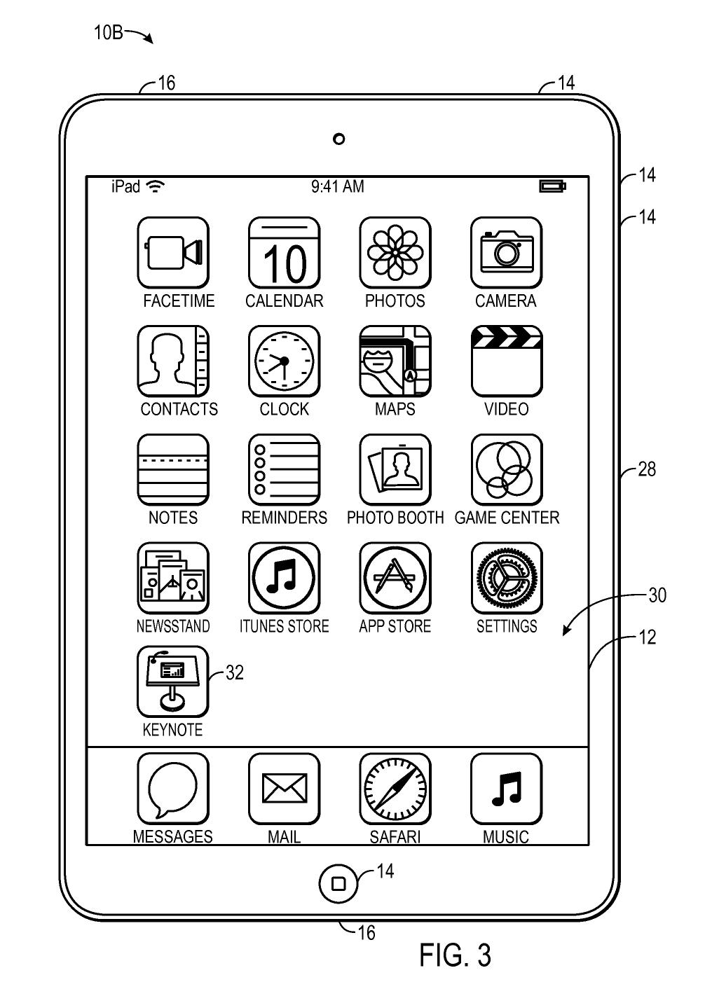

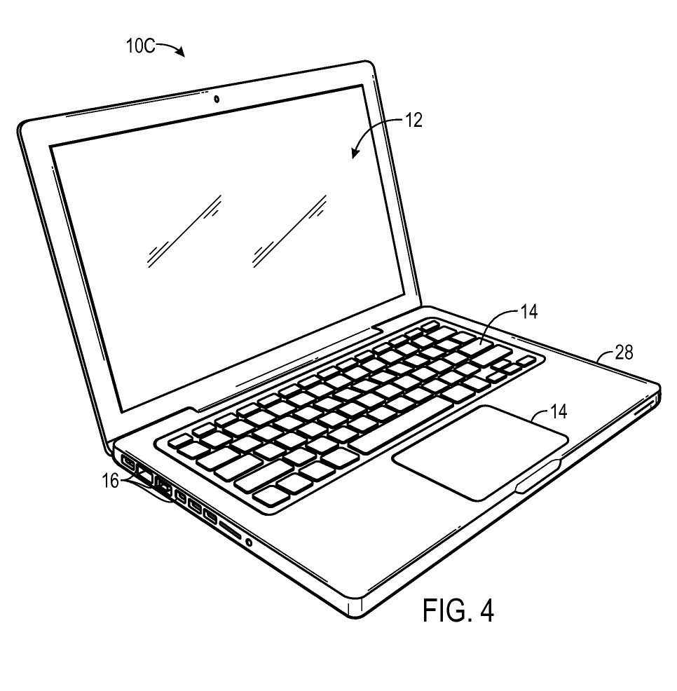

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., Keynote® by Apple Inc.).

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch a presentation application program (e.g., Keynote® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touchscreen features of the display 12 of the handheld device 10A may provide a simplified approach to controlling the presentation application program. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., Keynote® by Apple Inc.) running on the computer 10C.

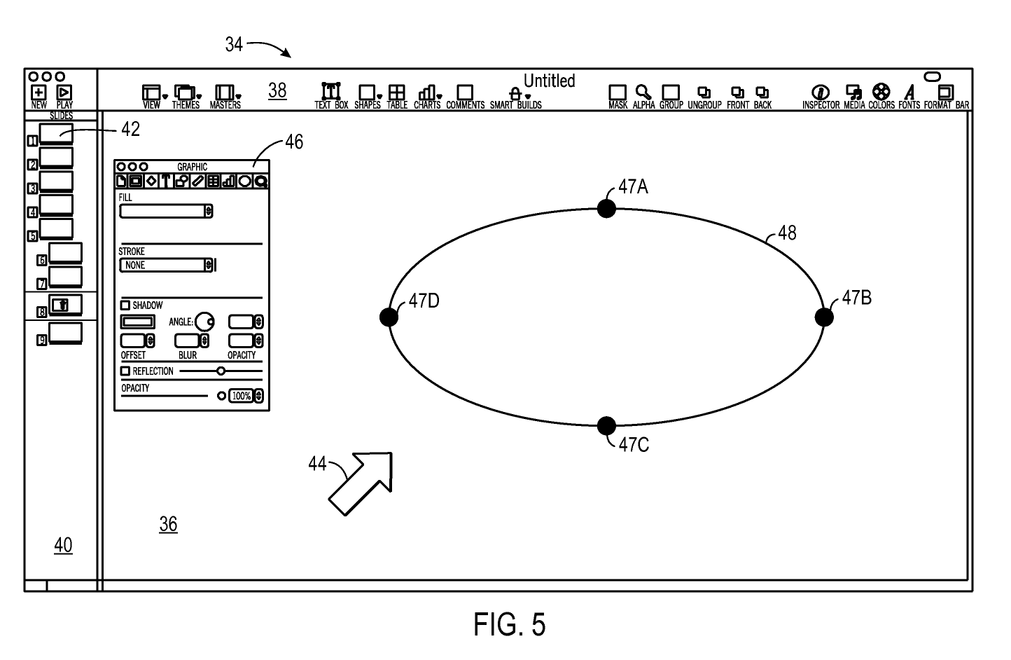

With the foregoing in mind, a variety of computer program products, such as applications or operating systems, may use the techniques discussed below to enhance the user experience on the electronic device 10. [Indeed, any suitable computer program product that includes a canvas (e.g., a drawing or presentation canvas) for displaying and/or editing shapes or images may employ the techniques discussed below.] For instance, the electronic device 10 may run a graphics editing program 34 (e.g., Paintbrush® from Apple Inc.) or presentation program 34 (e.g., Keynote® from Apple Inc.) as shown in FIG. 5. The editing program 34 shown in FIG. 5 may provide multiple modes of operation, such as an edit mode and a presentation mode. In FIG. 5, the editing program 34 is shown in the edit mode. In the edit mode, the editing program 34 may provide a convenient and user-friendly interface for a user to add, edit, remove, or otherwise modify one or more graphical objects created, for example, by a user of the program 34. To this end, the editing program 34 may, in some embodiments, include three panes: a canvas 36, a toolbar 38, and a slide organizer 40. The canvas 36 may display a currently selected slide 42 from among the slide organizer 40. A user may use a cursor 44 to add content to the canvas 36 using tool selections from the toolbar 38 or via a control window 46 that may be opened and/or displayed. Among other things, this content may include objects such as text boxes, images, shapes (e.g., vector shapes, such as lines, squares, circles, rectangles, triangles, other vector shape-types), and/or video objects. When in the edit mode, the user may add or remove objects and/or may assign actions and/or effects to one or more of the objects. In the presentation mode, the user may, for example, display a created slide or a sequence of slides in a format suitable for audience viewing.

As used herein, the term “object” refers to any individually editable component on a canvas (e.g., the canvas 36 of the editing program 34). That is, content that can be added to the canvas 36 and/or be altered or edited on the canvas 36 may constitute an object. For example, a graphic, such as an image, photo, line drawing, clip art, chart, or table, may be provided on a slide may constitute an object. In addition, a character or string of characters may constitute an object. Likewise, an embedded video clip may also constitute an object that is a component of the canvas 36. Applying changes or alterations of an object, such as to change its location, size, orientation, appearance or to change its content, may be understood to be changing a property of the object. Therefore, in certain embodiments, characters and/or character strings (alphabetic, numeric, and/or symbolic), image files (.jpg, .bmp, .gif, .tif, .png, .cgm, .svg, .pdf, .wmf, and so forth), video files (.avi, .mov, .mp4, .mpg, .qt, .rm, .swf, .wmv, and so forth) and other multimedia files or other files in general may constitute “objects” as used herein. In certain graphics processing contexts, the term “object” may be used interchangeably with terms such as “bitmap” or “texture.”

As previously discussed, in certain embodiments, the canvas 36 may include objects 48 such as text boxes, images, shapes (e.g., vector shapes, such as lines, squares, circles, rectangles, triangles, other vector shape-types), and/or video objects. Specifically, as further illustrated in FIG. 5, a graphical object 48 (e.g., that may have been created by a user or selected by the user from the control window 46) may be presented on the canvas 36. As it may be worth noting, although the graphical object 48 as depicted may be oval-shaped, it should be appreciated that the graphical object 48 may be of any shape (e.g., vector shape) including, for example, lines, squares, circles, rectangles, triangles, Bezier paths, Catmull-Rom splines, or other graphical objects.

In certain embodiments, to facilitate editing (e.g., resizing, reshaping, transforming, and so forth), the graphical object 48 may include a number of control nodes 47A, 47B, 47C, and 47D. The control nodes 47A, 47B, 47C, and 47D may be controlled by using, for example, the cursor 44 (e.g., graphical pointer or pen tool). As will be further appreciated, in certain embodiments, a user may use the control nodes 47A, 47B, 47C, and 47D to perform one or more edits of the graphical object 48. These edits may include, for example, moving one or more of the control nodes 47A, 47B, 47C, and 47D, deleting one or more of the nodes 47A, 47B, 47C, and 47D, toggling one or more types of nodes 47A, 47B, 47C, and 47D, and so forth.

However, in some embodiments, user edits (e.g. affine transformations) may lead to substantially distorted curves (e.g., distortion of the curve segments connecting the control nodes 47A, 47B, 47C, and 47D of a graphical object). Particularly, user edits that include affine transformations of a graphical object may cause the graphical object to exhibit a shape that may not entirely correspond to a mathematically even and/or mathematically ideal shape. For example, performing an affine transformation of, for example, a circle may present an oval shape (e.g., graphical object 48) instead of a mathematically ideal shape defined by a derived mathematical spline that passes through the nodes 47A, 47B, 47C, and 47D (e.g., having mathematically smoother curvature as compared to the oval shaped graphical object 48). As will be further appreciated, it may be useful to derive mathematically modeled shapes corresponding to the edit movement of the user and based on the distance (e.g., vector magnitude) and angle between the control nodes 47A, 47B, 47C, and 47D, to allow a user, for example, to perform desirable edits (e.g., modifications) of the graphical object 48 even when the object being edited (e.g., graphical object 48) does not entirely correspond to a mathematically even and/or mathematically smooth shape.

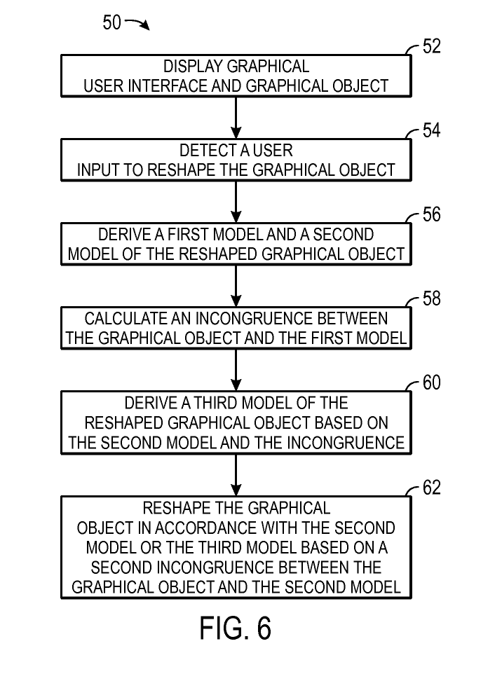

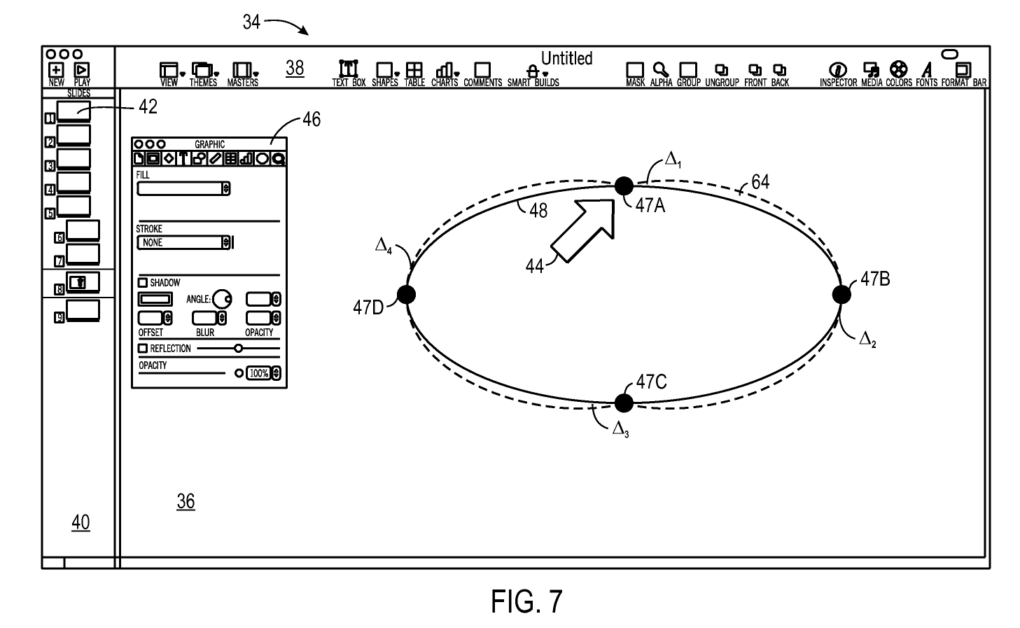

Accordingly, turning now to FIG. 6, a flow diagram is presented, illustrating an embodiment of a process 50 useful in deriving mathematically modeled objects and providing correcting distortion of the objects based on user editing by using, for example, the one or more processor(s) 18 included within the system 10 depicted in FIG. 1. For the purpose of illustration, henceforth, FIG. 6 may be discussed in conjunction with FIGS. 7-10. The process 50 may include code or instructions stored in a non-transitory machine-readable medium (e.g., the memory 20) and executed, for example, by the one or more processor(s) 18 included within the system 10. The process 50 may begin with the processor(s) 18 causing a display (e.g., display 12) to display (block 52 of FIG. 6) a graphical user interface (GUI) and a graphical object (e.g., graphical object 48). For example, as illustrated in FIG. 7, the graphical object 48, including the control nodes 47A, 47B, 47C, and 47D, may be displayed on the canvas 36 of the editing program and/or editing program 34 presented by the electronic device 10.

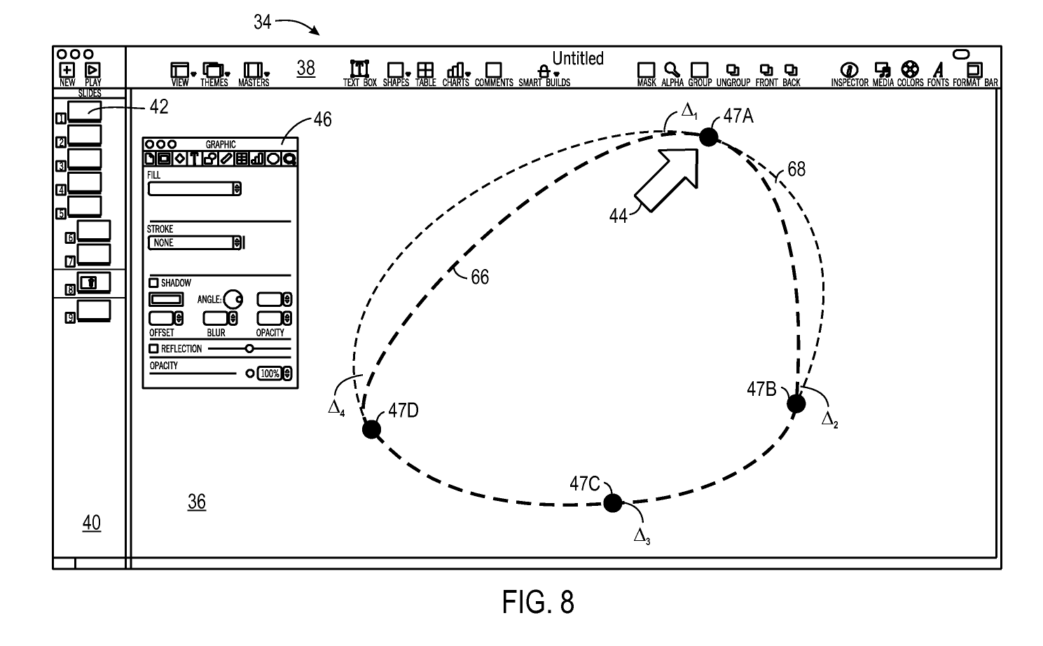

The process 50 may then continue with the processor(s) 18 detecting (block 54 of FIG. 6) a user input to reshape the graphical object 48. Specifically, referring again to FIG. 7, the processor(s) 18 may detect that a user has used the cursor 44 (e.g., pen tool) to command a movement of the control node 47A. For example, as depicted in FIG. 8, a user may use the cursor 44 to move the control node 47A in, for example, an upward-right direction resulting in a would-be distorted graphical object 66. However, the distorted graphical object 66 may not be viewable to the user. Instead, in response to detecting that the user, for example, has edited the graphical object 48, the process 50 may continue with the processor(s) 18 deriving (block 56 of FIG. 6) a first model 64 (as illustrated in FIG. 7) (which may not be viewable to the user) of the graphical object 48 and a second model 68 (as illustrated in FIG. 8) of the reshaped graphical object 48 in accordance with the detected user input. Specifically, the processor(s) 18 may derive the first model 64 (e.g., a mathematically even and smooth model) (as depicted in FIG. 7) of the graphical object 48 based on an original form of the graphical object 48 (e.g., before any user editing). Similarly, the processor(s) 18 may derive the second model 68 (e.g., a second mathematically even and smooth model) (as depicted in FIG. 8) of the graphical object 48 based on a distorted and/or form of the graphical object 48 (e.g., after the time a user begins editing).

That is, the processor(s) 18 may derive the first model 64 corresponding to a mathematically even and mathematically ideal model (e.g., having mathematically even and smooth curves, and/or substantially even concavity or convexity) of the original graphical object 48 (as depicted in FIG. 7). Likewise, the processor(s) 18 may also derive a predictive second model 68 corresponding to a mathematically even and/or mathematically ideal model (e.g., having mathematically even and smooth curves, and substantially even concavity or convexity) of the distorted graphical object 66 (as depicted in FIG. 8). As previously noted, the distorted graphical object 66 (as depicted in FIG. 8) may represent the original graphical object 48 generally after one or more edits have been performed on the original graphical object 48.

In certain embodiments, following the derivations of the first model 64 of the original graphical object 48 and the second model 68 of the distorted graphical object 66, the process 50 may then continue with the processor(s) 18 calculating (block 58 of FIG. 6) an incongruence between the original graphical object 48 and the first model 64 of the original graphical object 48. For example, as illustrated in FIG. 7, the processor(s) 18 may calculate one or more deltas (Δ₁, Δ₂, Δ₃, Δ₄) (e.g., offsets) between the original graphical object 48 and the first model 64 of the original graphical object 48. Specifically, the deltas (Δ₁, Δ₂, Δ₃, Δ₄) (e.g., offsets) may be a proximate measure of the degree of offset and/or distortion existing between the first model 64 of the original graphical object 48 and the original graphical object 48. In certain embodiments, again referring to FIG. 7, the deltas (Δ₁, Δ₂, Δ₃, Δ₄) (e.g., offsets) may be calculated with reference to each of the control nodes 47A, 47B, 47C, and 47D. For example, the processor(s) 18 may calculate the angle difference (e.g., minimum angle difference) with respect to each of the control nodes 47A, 47B, 47C, and 47D and the vector magnitude difference with respect to each of the control nodes 47A, 47B, 47C, and 47D as an indication of the offset between the first model 64 and the original graphical object 48.

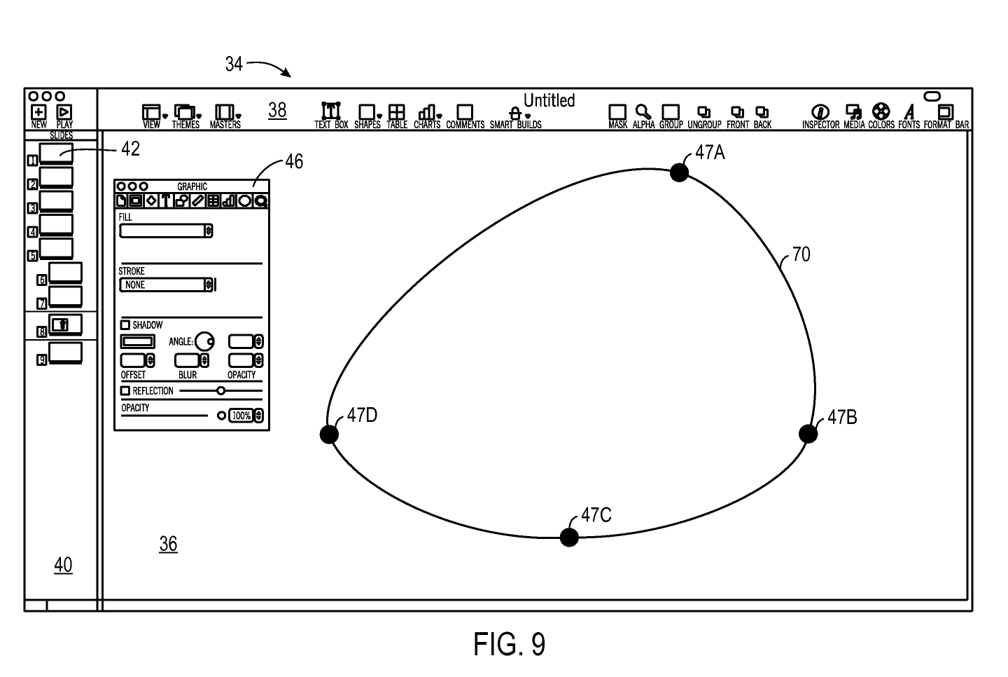

The process 50 may then continue with the processor(s) 18 deriving (block 60 of FIG. 6) a third model 70 (as depicted in FIG. 9) of the distorted (e.g., reshaped) graphical object 66 based on the second model 68 of distorted graphical object 66 and the incongruence (e.g., deltas (Δ₁, Δ₂, Δ₃, Δ₄)) calculated between the original graphical object 48 and the first model 64 (as previously discussed with respect to FIG. 7). Specifically, in referring to FIGS. 8 and 9, the processor(s) 18 may apply the calculated incongruence (e.g., deltas (Δ₁, Δ₂, Δ₃, Δ₄)) to the second model 68 of the distorted graphical object 66 (as depicted in FIG. 8) to derive the third model 70 (as depicted in FIG. 9). In this way, the third model 70 of the distorted graphical object 66 may be a representation (which may be viewable to the user) of the second model 68 including substantially the same degree of distortion as that present between the first model 64 and the original graphical object 48.

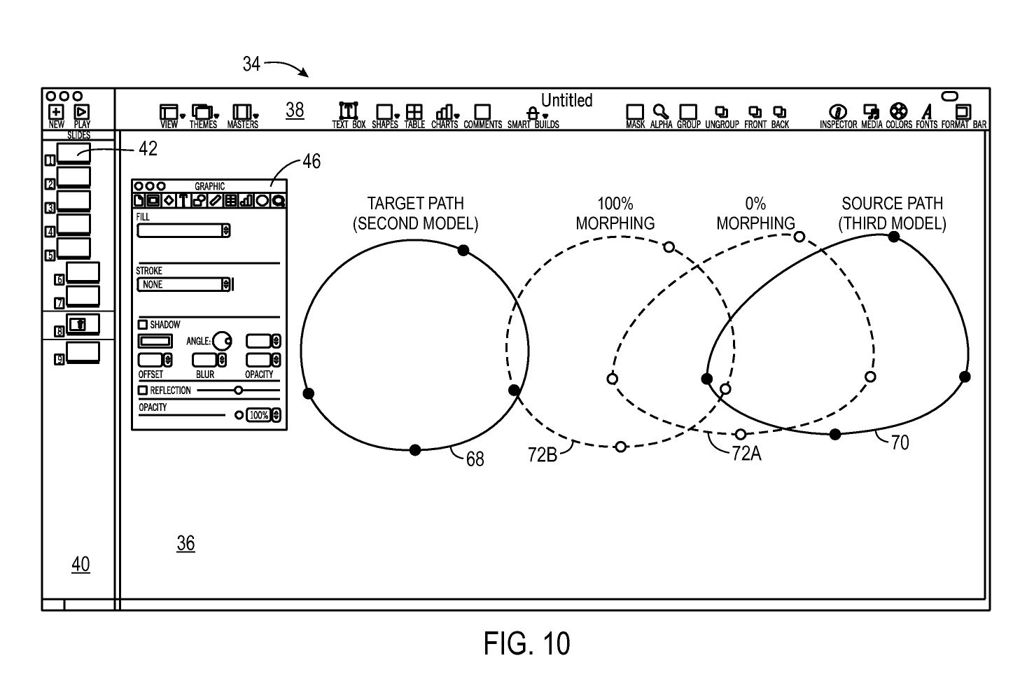

The process 50 may then conclude with the processor(s) 18 reshaping (block 62 of FIG. 6) the graphical object 48 (as depicted in FIG. 7) in accordance with the second model 64 (as depicted in FIG. 8) or the third model 70 (as depicted in FIG. 9) based on or more second incongruences calculated between the original graphical object 48 and the third model 70. For example, as illustrated by FIG. 10, the processor(s) 18 may calculate a “morphing percentage,” or a percentage value indicative of, and corresponding to, the degree in which the original graphical object 48 has been distorted and/or reshaped to produce the third model 70. As a further example, as illustrated by FIG. 10, based on the cursor 44 movement made by the user to initially distort and/or reshape the original graphical object 48, the processor(s) 18 may determine one or more possible resultant shapes (e.g., vector shapes, closed paths, and so forth) i.e., the second model 68 (target path) and the third model 70 (source path). That is, based on the user edit (e.g., resizing, reshaping, transforming, and so forth) of the original graphical object 48, the processor(s) may determine that the original graphical object 48 may ultimately morph toward a shape and/or form of the second model 68 (target path), the third model 70 (source path), or some shape and/or form therebetween.

As a further illustration, as depicted in FIG. 10, a 0% morphing percentage value (e.g., as illustrated by the morphing object 72A) may cause the original graphical object 48 to ultimately morph toward the shape and/or form of the third model 70 (source path). On the other hand, a 100% morphing percentage value (e.g., as illustrated by the morphing object 72B) may cause the original graphical object 48 to ultimately morph toward the shape of the second model 68 (target path). As it may be worth noting, it should appreciated that the original graphical object 48 may also be morphed into any shape and/or form between the morphing object 72A (e.g., 0% morphing percentage value) and the morphing object 72B (e.g., 100% morphing percentage value). That is, more significant the user edits (e.g., moving control nodes 47A, 47B, 47C, and 47D further distances or other significant distortion of the original graphical object 48) result in greater morphing percentage values (e.g., 60%, 70%, 80%, 90%, 100%), and thus the resulting form may appear closer to that of the second model 68 (target path). As will be further appreciated, for lesser significant user edits (e.g., edits corresponding to morphing percentage values of approximately 40%, 30%, 20%, 10%, or less), the resulting form may be substantially similar to that of the original graphical object 48.

Thus, as again illustrated by FIG. 10, and as previously noted, the final resultant form (e.g., upon completion of editing) of the original graphical object 48 may be that of the second model 68 (target path), the third model 70 (source path), or a combination (e.g., a form and/or shape therebetween) of the second model 68 (target path) and the third model 70 (source path). In this way, the present embodiments may ensure that as a user, for example, edits the original graphical object 48, the final resulting form will morph towards a shape having mathematically even and smooth curves and concavity or convexity (e.g., the second model 68, the third model 70, or some combination thereof). Thus, the present techniques may facilitate graphical object editing by allowing the user to edit an object that may not correspond to a mathematically smooth spline.

In other embodiments, the morphing percentage values calculated by the processor(s) 18 may not be uniform across an edited object (e.g., original graphical object 48), but instead may be calculated per control node 47A, 47B, 47C, and 47D. In this manner, a more significant edit (e.g., a bend or non-uniform scaling of only the curve segment between control nodes 47A and 47B, as opposed to the other curve segments) of a portion (e.g., curve segment) of the original graphical object 48 may not affect the morphing percentage values calculated with respect to the other control nodes (e.g., control nodes 47C and 47D) and/or the curves that connect the other control nodes.

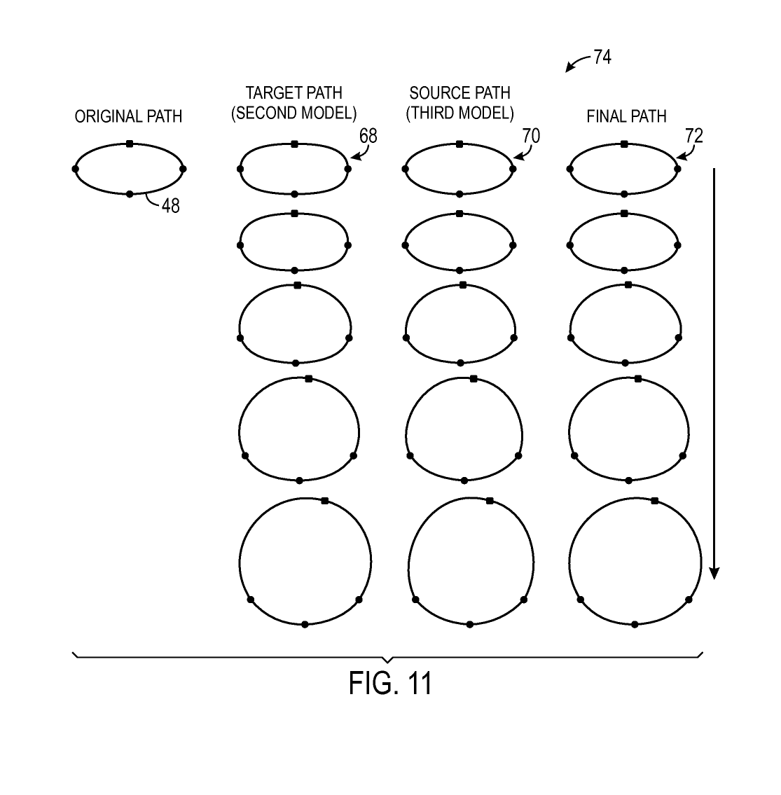

Turning now to FIGS. 11, 12, and 13, additional example diagrams 74, 76, and 78 of the graphical object editing techniques as discussed above with respect to FIGS. 6-10 are presented. Indeed, while the present techniques have been primarily illustrated with respect to editing circularly formed curves, it should be appreciated that the present techniques may be applied in the editing of any graphical objects, shapes, paths (e.g., open and closed paths), graphical text, or any such object that may be presented on the canvas 36 of the editing program 34. For example, the diagram 74 of FIG. 11 illustrates the original graphical object 48 (original path), and further provides various user edits and the resulting reshaped graphical objects. As illustrated in FIG. 11, the target path column corresponds to the derived second models 68, the source path column corresponds to the derived third models 70, and the final path column corresponds to a resulting graphical object 72 derived based on, for example, the user edits and the object editing techniques discussed herein. As illustrated in the first 2-3 rows of the diagram 74 presented in FIG. 11, the user makes lesser significant edits (e.g., edits corresponding to morphing percentage values of approximately 40%, 30%, 20%, 10%, or less), and thus the resulting graphical object 72 (final path) (e.g., which is viewable to the user) may tend toward the form of the third model 70, and appear substantially similar to the original graphical object 48. However, as the user performs more significant edits (e.g., edits corresponding to morphing percentage values of approximately 60%, 70%, 80%, 90%, 100%) as illustrated by the last 1-2 rows of the diagram 74, the resulting graphical object 72 (final path) may begin to tend toward the form of the second model 68 (target path), and thus appear substantially similar to the second model 68.

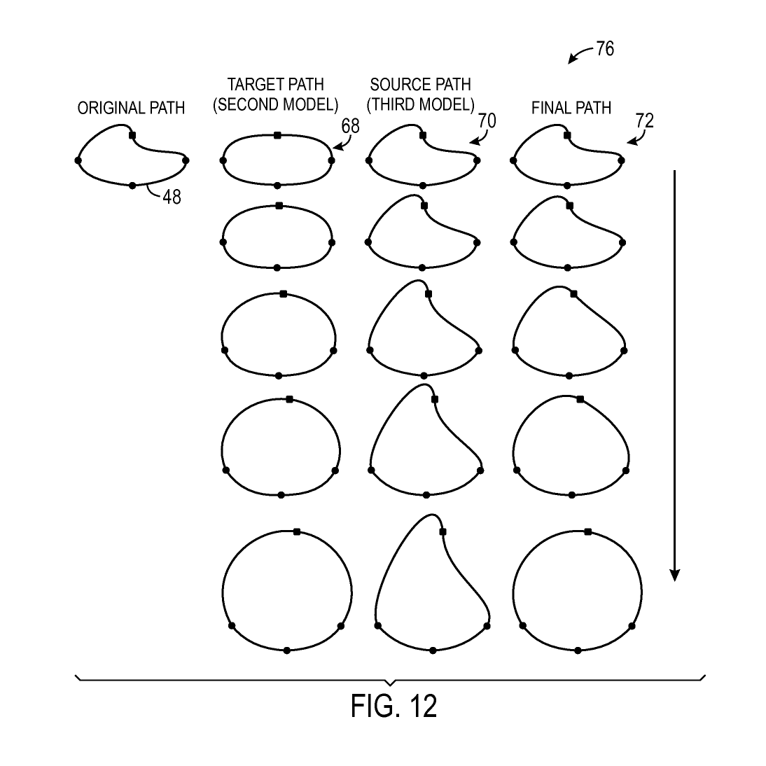

In a similar example, as illustrated by the diagram 76 of FIG. 12, the user again begins by making lesser significant edits (e.g., edits corresponding to morphing percentage values of approximately of 40%, 30%, 20%, 10%, or less), and thus the resulting graphical object 72 (final path) (e.g., which is viewable to the user) may tend toward the shape and/or form of third model 70, and appear substantially similar to the original graphical object 48. However, it should again be appreciated that based on the user edit (e.g., resizing, reshaping, transforming, and so forth) of the original graphical object 48, the original graphical object 48 may ultimately morph toward a shape and/or form of the second model 68 (target path), the third model 70 (source path), or some shape and/or form therebetween. For example, again as the user perform a more significant edit (e.g., edits corresponding to morphing percentage values of approximately 60%, 70%, 80%, 90%, 100%), the original graphical object 48 may then morph toward a shape and/or form consistent with that of the second model 68 (target path). This is again illustrated by the last 2-3 rows of the diagram 76 of FIG. 12.

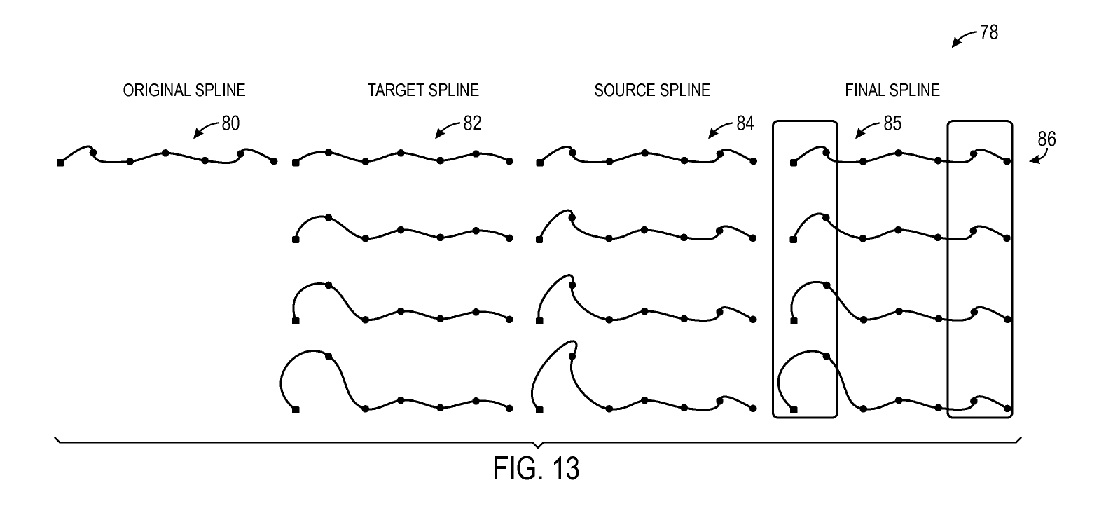

In certain embodiments, as illustrated by the diagram 78 of FIG. 13, the user may edit an original spline 80 of a shape and/or curve. In one embodiment, the original spline 80 may be a Catmull-Rom spline, on which the user may desire to perform one or more affine transformations (e.g., uniform and/or non-uniform scaling, rotating, skewing, translating, reflecting, shearing, and so forth). However, in other embodiments, the spline 80 may include a cardinal spline, a Kochanek-Bartels spline, or any of various similar splines. Similar to that discussed above with respect to FIGS. 11 and 12, the diagram 78 of FIG. 13 includes target spline column corresponding to a derived target spline model 82 (e.g., similar to the second model 68), a source spline column corresponding to a derived source spline model 84, and a final spline column including final spline segment portions 85 and 86.

In each of the examples of FIG. 13, the user makes edits (e.g., bends) to only the beginning portion of the original segment 80. As the user makes lesser significant edits (e.g., edits corresponding to morphing percentage values of approximately of 40% 40%, 30%, 20%, 10%, or less), the resulting final spline portion 85 may tend toward the form of the target model segment 84, while the final spline portion 86 (e.g., unedited portion) may remain unchanged from the original segment 80. On the other hand, as the user performs more significant edits (e.g., edits corresponding to morphing percentage values of approximately 60%, 70%, 80%, 90%, 100%) as illustrated by the last 2-3 rows of the diagram 78, the final spline portion 85 may begin to tend toward the form of the source model segment 82, while the final spline portion 86 (e.g., unedited portion) may again remain unchanged from the original segment 80. In this way, the present embodiments may ensure that as a user performs edits such as, for example, affine transformations of the original spline 80 (e.g., spline) and/or portions of the original segment 80, the final resulting segment (e.g., spline) will morph toward a shape and/or form having mathematically even and smooth curves and concavity or convexity (e.g., based on the source model segment 82, the target model segment 84, or some combination thereof). That is, the present techniques may facilitate graphical object editing by allowing the user to edit an object and/or a portion of an object that may not correspond to a mathematically ideal function.

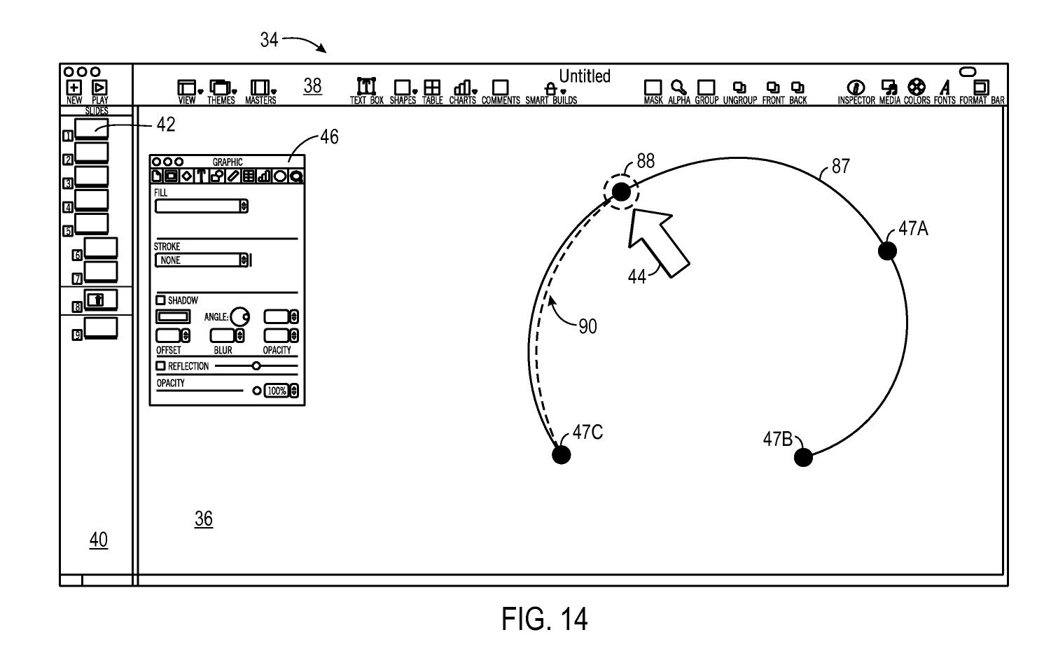

In some embodiments, as illustrated with respect to FIG. 14, upon a user using the cursor 44 (e.g., pen tool) to hover over any point on a graphical object 87 apart from the control nodes 47A, 47B, and 47C, an add-node 88 (e.g., additional control node) may appear at a point substantially center of the segment to which the cursor 44 is directed. However, it should be appreciated that, in other embodiments, the add-node 88 may not appear in the center of a given segment of the graphical object 87, and instead appear anywhere along the graphical object 87 corresponding to the position of the cursor 44 (e.g., pen tool). Yet still, in other embodiments, multiple add-nodes 88 may appear concurrently as the user performs one or more edits of the graphical object 87.

In certain embodiments, when the add-node 88 appears on the graphical object 87, the ideal mathematical model and/or ideal mathematical function that may have been used to define the graphical object 87 (e.g., before the appearance of the add-node 88) may be readjusted based on the position of the add-node 88. This may result in one or more segments of the graphical object 87 that pass through the add-node 88 being readjusted, and thus the graphical object 87 may represent a new mathematically ideal shape and/or form based on the position of the add-node 88. For example, as depicted in FIG. 14, the segment 90 (dashed line 90) may represent the path through control nodes 47B and 47A before the appearance of the add-node 88. Specifically, because of the appearance of the add-node 88, the segment of the graphical object 87 passing through control nodes 47C and add-node 88 has been reshaped to correspond to a newly calculated mathematically ideal function based on the position of the add-node 88 and/or the displacement from the original segment 90 (dashed line 90). In this manner, the present embodiments may allow the add-node 88 to be added to the graphical object 87 while retaining the original shape of the graphical object 87. In such cases, the user may perceive no change of the graphical object 87.

In other embodiments, as further depicted in FIG. 14, upon the appearance of one or more add-nodes 88, the user may then use the one or more add-nodes 88 to perform edits (e.g., affine transformations) to the graphical object 87. That is, the add-node 88 may be used to distort and/or reshape the graphical object 87 in a similar manner as the control nodes 47A, 47B, 47C, and 47D of graphical object 48 are used as discussed above with respect to FIGS. 7-10. However, in regard specifically to the add-node 88, selecting (e.g., clicking or touching) the add-node 88 and dragging the add-node 88 may distort and/or reshape only the segment of the graphical object 87 on which the add-node 88 appears. For example, a user edit in which the user moves the add-node 88 in a particular direction, only that particular segment is distorted. In this manner, as the user drags the add-node 88 in any of various directions, only the segment nearest to, or between, the nearest control node(s) (e.g., control node 47C, control node 47A, or both) may be edited. This may ensure that any distortionary effect resulting from the user edit via the add-node 88 may be localized around the nearest control node 47A, 47B, and 47C and/or segment. Indeed, one or more mathematical adjustments (e.g., position adjustments, displacement adjustments, distance adjustments, and so forth) may be performed (e.g., by the processor(s) 18) to ensure that the add-node 88 the user is dragging on the graphical object 87 changes with the distance the user is to the nearest control node 47A, 47B, and 47C.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method, comprising:
displaying on a display of an electronic device a graphical user interface (GUI) comprising a graphical object, wherein the graphical object comprises one or more controllable graphical nodes;
detecting a user input via a processor of the electronic device, wherein the user input comprises a selection of the one or more controllable graphical nodes to reshape the graphical object;
deriving, via the processor, a first model of the graphical object and a second model of the reshaped graphical object according to the detected user input;
calculating, via the processor, an incongruence between the graphical object and the first model of the graphical object;
deriving, via the processor, a third model of the reshaped graphical object based at least in part on the second model of the reshaped graphical object and the incongruence; and
reshaping the graphical object in accordance with the second model or the third model based at least in part on a value of a second incongruence calculated between the graphical object and the third model of the reshaped graphical object.

2. The method of claim 1, wherein detecting a user input comprises detecting a user click and drag or a user touch and drag of the one or more controllable graphical nodes.

3. The method of claim 1, wherein detecting a user input to reshape the graphical object comprises detecting an input to perform one or more manipulations of the one or more controllable graphical nodes.

4. The method of claim 1, wherein deriving the first model of the graphical object comprises deriving a mathematical model of the graphical object based thereon, wherein the mathematical model of the graphical object comprises substantially even curvature as compared to that of the graphical object.

5. The method of claim 1, wherein deriving the second model comprises deriving a mathematical model of the reshaped graphical object based thereon, wherein the mathematical model of the reshaped graphical object comprises substantially even curvature as compared to that of the reshaped graphical object.

6. The method of claim 1, wherein calculating the incongruence comprises calculating a degree of offset between the graphical object and the first model of the graphical object.

7. The method of claim 6, wherein calculating the degree of offset comprises calculating an angle difference and a vector magnitude difference between the first model and the graphical object.

8. The method of claim 1, wherein deriving the third model of the reshaped graphical object comprises:
computing an amount of offset between the graphical object and the first model of the graphical object; and
applying the amount of offset to the second model of the reshaped graphical object to derive the third model.

9. The method of claim 1, wherein reshaping the graphical object in accordance with the second model or the third model comprises morphing the graphical object to exhibit a form of the second model, a form of the third model, or some form therebetween.

10. The method of claim 1, wherein reshaping the graphical object in accordance with the second model or the third model comprises morphing the graphical object to exhibit a form of the second model when the second incongruence is of a first range of percentage values, and to exhibit a form of the third model when the second incongruence is of a second range of percentage values, wherein the first range of percentage values is greater than the second range of percentage values.

11. A non-transitory computer-readable medium having computer executable code stored thereon, the code comprising instructions to:
display a graphical user interface (GUI) on an electronic device, wherein the GUI comprises a graphical vector shape including a plurality of control points;
receive a user input, wherein the user input comprises a movement of one of the plurality of control points to distort the graphical vector shape;
derive a first mathematical model of the graphical vector shape and a second mathematical model of the graphical vector shape, wherein the second mathematical model is derived according to the distortion of the graphical vector shape;
calculate one or more values indicative of an offset between the graphical vector shape and the first model of the graphical vector shape;
derive a third mathematical model of the graphical vector shape by utilizing the one or more values, such that a form of the third mathematical model substantially corresponds to the offset between the graphical vector shape and the first model of the graphical vector shape; and
presenting the graphical vector shape based at least on the form of the third mathematical model.

12. The non-transitory computer-readable medium of claim 11, wherein the code comprises instructions to receive the user input to distort the graphical vector shape by way of uniform scaling, non-uniform scaling, rotation, skewing, translation, reflection, shearing, or any combination thereof.

13. The non-transitory computer-readable medium of claim 11, wherein the code comprises instructions to receive the user input to distort at least one portion of the graphical vector shape.

14. The non-transitory computer-readable medium of claim 11, wherein the code comprises instructions to derive the first mathematical model to comprise mathematically smooth vector curves as compared to the graphical vector shape.

15. The non-transitory computer-readable medium of claim 11, wherein the code comprises instructions to derive the second mathematical model to comprise mathematically smooth vector curves as compared to the distorted graphical vector shape.

16. The non-transitory computer-readable medium of claim 11, wherein the code comprises instructions to calculate the one or more values indicative of the offset by calculating an angle difference and a vector magnitude difference between the first mathematical model and the graphical vector shape.

17. The non-transitory computer-readable medium of claim 11, wherein the code comprises instructions to morph the graphical vector shape to reflect a form of the second mathematical model, the form of the third mathematical model, or some combination thereof.

18. An electronic device, comprising:
a display configured to display a graphical object; and
a processor configured to:
determine a first mathematical model of the graphical object and a second mathematical model of the graphical object upon receiving a user selection to distort the graphical object;
compute a first incongruence between the graphical object and the first model of the graphical object;
determine a third mathematical model of the graphical object based at least in part on the second model of the graphical object and the first incongruence;
compute a second incongruence between the graphical object and the third mathematical model of the graphical object, wherein the second incongruence comprises an object morphing percentage value; and
transform the graphical object in accordance with the second mathematical model or the third mathematical model based at least in part on whether the object morphing percentage value comprises a value of a first range of percentage values or a second range of percentage values.

19. The electronic device of claim 18, wherein the display is configured to display a Bezier path, a Hobby curve, a Catmull-Rom spline, or any combination thereof, as the graphical object.

20. The electronic device of claim 18, wherein the processor is configured to transform the graphical object to display a form of the second mathematical model when the object morphing percentage value comprises a value of the first range of percentage values and to display a form of the third mathematical model when the object morphing percentage value comprises a value of the second range of percentage values.

21. The electronic device of claim 18, wherein the first range of percentage values is greater than the second range of percentage values.

22. The electronic device of claim 18, wherein the processor is configured to not transform the graphical object when the object morphing percentage value comprises a lowest value of the second range of percentage values.

23. An electronic device, comprising:
a processor configured to:
cause a display device to display a graphical spline, wherein the graphical spline comprises a plurality of spline segments connected via a plurality of graphical nodes;
detect a user input, wherein the user input comprises an input to distort at least one of the plurality of spline segments;
derive a source spline model of the graphical spline and a target spline model of the graphical spline, wherein the source spline model corresponds to an original form of the graphical spline, and wherein the target spline model corresponds to a distorted form of the graphical spline;
compute a plurality of morphing values associated with a user editing of the graphical spline; and
morph the graphical spline between the original form of the graphical spline and the distorted form of the graphical spline based on the plurality of morphing values.

24. The electronic device of claim 23, wherein the processor is configured to morph only the at least one distorted spline segment.

25. A method, comprising:
displaying on a display of an electronic device a vector drawing object, wherein the vector drawing object comprises a plurality of controllable nodes;
detecting a user input via a processor of the electronic device, wherein the user input comprises a hover along one or more portions of the vector drawing object; and
generating an additional controllable node thereon the one or more portions in response to the user input, wherein the additional controllable node is configured to allow a user to distort only the one or more portions of the vector drawing object on which the additional controllable node appears.

26. The method of claim 25, comprising generating the additional controllable node to appear substantially center of at least two of the plurality of controllable nodes of the vector drawing object.
